(19) United States
(12) Patent Application Publication
(10) Pub. No.: US 2015/0329757 A1
(43) Pub. Date: Nov. 19, 2015

(54) REDUCING FLAMMABILITY OF HYDROCARBON REFRIGERANTS WHILE MAINTAINING REFRIGERATING CAPACITY

(71) Applicant: James B. Tieken, Henderson, NV (US)

(72) Inventor: James B. Tieken, Henderson, NV (US)

(21) Appl. No.: 14/281,299

(22) Filed: May 19, 2014

(51) Int. Cl. C09K 5/04

(52) U.S. Cl. CPC C09K 5/044

(57) ABSTRACT

Hydrocarbon refrigerant blends having reduced flammability are disclosed. The blends may have a relatively low halocarbon content to maintain favorable environmental, performance, and toxicity parameters.

### FIELD OF THE DISCLOSURE

The present disclosure relates to refrigerants. More particularly, the present disclosure relates to hydrocarbon refrigerants having reduced flammability.

### BACKGROUND OF THE DISCLOSURE

Refrigerants are substances used in refrigeration processes to pick up heat from one area and deposit it in another area. Refrigeration processes are usually executed by boiling a refrigerant from a liquid to a gas to pick up heat, and cooling and condensing the gas to deposit the heat.

Many substances have been used over the years as refrigerants. Most refrigerants in use today are halocarbons, and more specifically fluorocarbons (FCs), such as clorofluorocarbons (CFCs), hydrochlorofluorocarbons (HCFCs), and hydrofluorocarbons (HFCs). Other substances that have limited use as refrigerants include hydrocarbons and ammonia, for example.

Halocarbon refrigerants, such as CFCs, HCFCs, and HFCs, are predominately used as refrigerants because they are generally nontoxic, nonflammable, and relatively safe to use. By contrast, hydrocarbons are extremely flammable, and ammonia is somewhat flammable. However, halocarbon refrigerants have come under fire during the last 30 years by scientists, environmental groups, and the United States Environmental Protection Agency (USEPA). Scientists have concluded that CFCs and HCFCs damage the earth's ozone layer. Scientists have also concluded that HFCs act as global warming gases, trapping heat in the earth's atmosphere and contributing to global warming. CFCs were phased out of production in the US in 1995. HCFCs are currently being phased out in the US, with the phase out set to be complete in the US by 2020. International talks have also begun to start phasing down production of HFCs worldwide.

Hydrocarbon refrigerants have been shown to be very good refrigerating compounds, with refrigerating capacities equal to, or better than, some halocarbon refrigerants. Also, hydrocarbon refrigerants generally have favorable environmental and toxicity parameters. However, because hydrocarbon refrigerants are extremely flammable, the USEPA has only approved hydrocarbon refrigerants for use in limited applications, usually with very small charge sizes to limit their flammable effect. Hydrocarbons such as isobutane, for example, are currently only approved for use in small pieces of refrigeration equipment to minimize the damage associated with a potential flame or explosion in the equipment.

### SUMMARY OF THE DISCLOSURE

The present disclosure relates to hydrocarbon refrigerant blends having reduced flammability. The blends may have a relatively low halocarbon content to maintain favorable environmental, performance, and toxicity parameters.

According to an embodiment of the present disclosure, a refrigerant blend is provided including a first percentage of at least one hydrocarbon refrigerant, the at least one hydrocarbon refrigerant having a flammability and a refrigerating capacity, and a second percentage of at least one halocarbon refrigerant that reduces the flammability of the at least one hydrocarbon refrigerant by a third percentage, wherein the second percentage is less than the third percentage, and wherein the refrigerant blend has a refrigerating capacity greater than or substantially equal to the refrigerating capacity of the at least one hydrocarbon refrigerant.

According to another embodiment of the present disclosure, a refrigerant blend is provided including at least one hydrocarbon refrigerant having a hydrocarbon content in the refrigerant blend, the at least one hydrocarbon refrigerant having a flammability, and at least one halocarbon refrigerant having a halocarbon content in the refrigerant blend to reduce the flammability of the at least one hydrocarbon refrigerant, wherein the refrigerant blend has a global warming potential (GWP) of about 600 or less.

According to yet another embodiment of the present disclosure, a method is provided for producing a refrigerant blend. The method includes providing at least one hydrocarbon refrigerant having a flammability, reducing the flammability of the at least one hydrocarbon refrigerant by adding at least one halocarbon refrigerant to the at least one hydrocarbon refrigerant to produce a refrigerant blend, and maintaining a global warming potential (GWP) of the refrigerant blend at about 600 or less.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawing, wherein:

FIG. 1 is a schematic view of a refrigeration system of the present disclosure.

The exemplifications set out herein illustrate exemplary embodiments of the invention and such exemplifications are not to be construed as limiting the scope of the invention in any manner.

### DETAILED DESCRIPTION

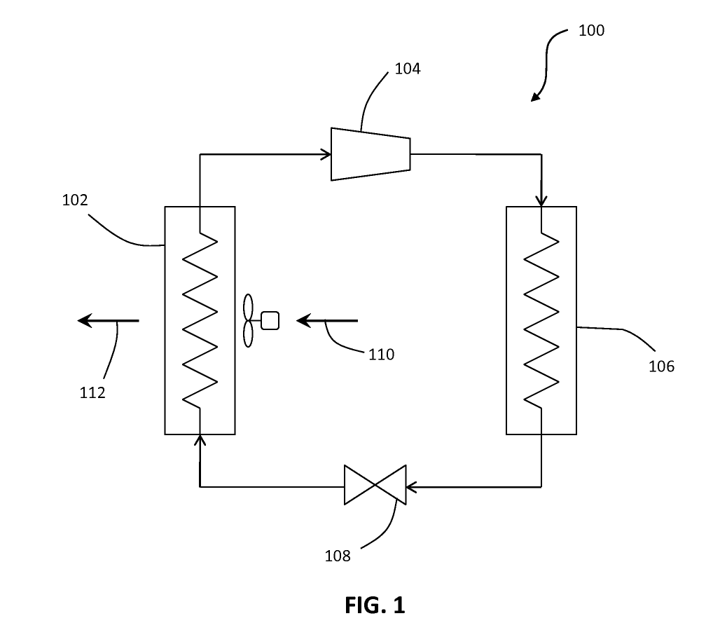

A refrigeration system 100 is illustrated schematically in FIG. 1. The illustrative refrigeration system 100 includes a first heat exchanger in the form of an evaporator 102, a compressor 104, a second heat exchanger in the form of a condenser 106, and an expansion valve 108. A desired refrigerant cycles repeatedly through the refrigeration system 100. In the evaporator 102, the refrigerant takes in heat from a relatively hot input 110 (e.g., ambient air) to produce a relatively cold output 112 (e.g., cooled air). The heated refrigerant from the evaporator 102 vaporizes and continues to the compressor 104, where the refrigerant is pressurized, and then to the condenser 106, where the refrigerant condenses and releases heat. The cooled refrigerant from the condenser 106 continues through the expansion valve 108, where the refrigerant is depressurized. The cooled refrigerant then returns to the evaporator 102 to provide more cooling of the relatively hot input 110.

The refrigerant for use in refrigeration system 100 of FIG. 1 or another suitable system may be a halocarbon-hydrocarbon blend of at least one halocarbon refrigerant, such as at least one FC refrigerant, and at least one hydrocarbon refrigerant. Examples of suitable halocarbon and hydrocarbon refrigerants for use in the blend are identified in Table 1 below:

TABLE 1

| | | Refrigerant | | Environmental | | | Flammability | | |
|---|---|---|---|---|---|---|---|---|---|
| Type | | Number | Name | GWP | ODP | COP | LFL | UFL | Δ |
| Halocarbon | CFC | R-11 | trichlorofluoromethane | 4,750 | 1 | | | | |
| | CFC | R-12 | dichlorodifluoromethane | 10,900 | 1 | | | | |
| | HCFC | R-22 | chlorodifluoromethane | 1,810 | 0.055 | | | | |
| | HFC | R-32 | difluoromethane | 675 | | | | | |
| | HCFC | R-124 | chlorotetrafluoroethane | 609 | | | | | |
| | HFC | R-125 | pentafluoroethane | 3,500 | | 4.23 | N/A | N/A | N/A |
| | HFC | R-134a | tetrafluoroethane | 1,430 | 0 | 3.65 | N/A | N/A | N/A |
| | HCFC | R-142b | chlorodifluoroethane | 2,310 | | | | | |
| | HFC | R-152a | difluoroethane | 124 | | | | | |

| | | | | | | | | |
|---|---|---|---|---|---|---|---|---|
| Hydrocarbon | R-50 | methane | 25 | | | | | |
| | R-170 | ethane | 5.5 | | | | | |
| | R-290 | propane | 3.3 | 0 | 4.66 | 2.1% | 10.1% | 8.0% |
| | | cyclopropane | | | | | | |
| | R-600 | butane | 4.0 | 0 | | | | |
| | R-600a | isobutane | 3 | 0 | 2.87 | 1.8% | 9.6% | 7.8% |
| | R-601 | pentane | <25 | 0 | | | | |
| | | heptane | 3 | 0 | | | | |

According to an exemplary embodiment of the present disclosure, the blend may contain a relatively small amount by weight of the one or more halocarbon refrigerants and a relatively large amount by weight of the one or more hydrocarbon refrigerants. For example, the hydrocarbon content may be at least about 4, 8, 12, or 16 times greater than the halocarbon content. In certain embodiments, the blend may have a total halocarbon content as low as about 2, 4, 6, 8, or 10 weight % and as high as about 12, 14, 16, 18, or 20 weight %, or within any range delimited by any pair of the foregoing values, for example. The one or more hydrocarbon refrigerants may make up the balance of the blend. The halocarbon content and hydrocarbon content may be chosen to form a substantially azeotropic blend, so that if a leak formed in the system, both substances would leak from the system at about the same rate. Several exemplary blends (B-1 to B-4) are set forth in Table 2 below:

TABLE 2

| | | Amount |
|---|---|---|
| Blend | Ingredients | (by weight) |
| B-1 | halocarbon | 5% |
| | hydrocarbon | 95% |
| | Total | 100% |
| B-2 | halocarbon | 10% |
| | hydrocarbon | 90% |
| | Total | 100% |
| B-3 | halocarbon | 15% |
| | hydrocarbon | 85% |
| | Total | 100% |
| B-4 | halocarbon | 20% |
| | hydrocarbon | 80% |
| | Total | 100% |

Each ingredient and/or blend may be classified and evaluated based on the following parameters.

Refrigerant Number. The Refrigerant Number of each ingredient and/or blend may be obtained from Standard 34 of the American Society of Heating, Refrigerating and Air Conditioning Engineers (ASHRAE), entitled “Designation and Safety Classification of Refrigerants,” or from other suitable sources. Exemplary Refrigerant Numbers are presented for certain ingredients in Table 1 above.

Global Warming Potential (GWP). GWP represents the environmental impact of a gas in terms of the total energy that the gas is expected to absorb or trap over a particular time period compared to an equivalent mass of carbon dioxide. The larger the GWP, the more warming the gas is expected to cause. For example, a GWP of 25 would mean that the gas is expected to trap 25 times as much heat, and therefore cause 25 times as much warming, as an equivalent mass of carbon dioxide over a certain time period. Halocarbon refrigerants, such as CFCs, HCFCs, and HFCs, are generally considered “high-GWP” gases, because they trap substantially more heat than an equivalent mass of carbon dioxide. Hydrocarbon refrigerants, by contrast, are generally considered “low-GWP” gases. GWP values of the present disclosure may be based upon a 100 year time horizon.

For each ingredient, GWP values may be obtained from the Fourth Assessment Report (AR4) by the Intergovernmental Panel on Climate Change (IPCC), the disclosure of which is expressly incorporated herein by reference in its entirety. Other suitable GWP values may also be obtained from the USEPA, for example. Exemplary GWP values are presented for certain ingredients in Table 1 above.

For the blend, GWP Blend Blend may be calculated as a weighted average of the individual GWP values in the blend, taking into account the amount (e.g., weight %) of each ingredient (1−n) in the blend, as shown in Equation (1) below:

GWP_{Blend}=Amount₁(GWP₁)+Amount₂(GWP₂)+ . . . Amountₙ(GWPₙ) (1)

According to an exemplary embodiment of the present disclosure, the halocarbon content of the blend may be small enough to maintain a low GWP_{Blend}. In certain embodiments, GWP_{Blend} may be less than about 600. For example, GWP_{Blend} may be as low as about 100, 200, or 300 and as high as about 400, 500, or 600, or within any range delimited by any pair of the foregoing values. In these embodiments, the blend may qualify as a “low-GWP” refrigerant by current USEPA standards.

Ozone Depletion Potential (ODP). ODP represents the environmental impact of each ingredient in terms of the degradation to the ozone layer that the ingredient is expected to cause relative to trichlorofluoromethane. In general, the ODP decreases as the hydrogen content increases and as the chlorine content decreases relative to trichlorofluoromethane.

For each ingredient, ODP may be obtained from USEPA, IPCC, or other suitable sources. Exemplary ODP values are presented for certain ingredients in Table 1 above.

For the blend, ODP_{Blend} may be calculated as a weighted average of the individual ODP values in the blend, taking into account the amount (e.g., weight %) of each ingredient (1−n) in the blend, as shown in Equation (2) below:

ODP_{Blend}=Amount₁(ODP₁)+Amount₂(ODP₂)+ . . . Amountₙ(ODPₙ) (2)

According to an exemplary embodiment of the present disclosure, the hydrocarbon content of the blend may be large enough to maintain a low ODP_{Blend}. For example, ODP_{Blend} may be 0 or less than about 0.05, 0.1, 0.15, or 0.2.

Coefficient of Performance (COP). COP of each ingredient and/or blend may be calculated according to Equation (3) below, where Q_{L} is a desired output or refrigerating capacity and Wᵢₙ is the amount of electrical energy used to achieve that refrigerating capacity.

COP=Q_{L}/Wᵢₙ (3)

The refrigerating capacity (Q_{L}) and the energy input (Wᵢₙ) may be expressed in units of kilowatts (kW) or tons of refrigeration (TR), for example. The higher the COP, the more efficient the refrigerant. COP may be measured using a test stand with electrical and temperature measuring devices and water as a heat sink material.

According to an exemplary embodiment of the present disclosure, the COP of the blend (i.e., with the halocarbon refrigerants) may be the same as, substantially the same as, or greater than the COP of the hydrocarbon refrigerants alone (i.e., without the halocarbon refrigerants) when tested under the same conditions. In certain embodiments, the COP of the blend may be substantially the same as the COP of the hydrocarbon alone by being within about 0.1%, 0.5%, 1.0%, 1.5%, or 2.0% of the COP of the hydrocarbon alone. For example, if the COP of the hydrocarbon alone is 3.0, the COP of the blend may differ by about 0.06 or less. If the COP of the blend is the same as, substantially the same as, or greater than the COP of the hydrocarbon refrigerants alone, the refrigerating capacity (Q_{L}) of the blend would also be the same as, substantially the same as, or greater than the refrigerating capacity (Q_{L}) of the hydrocarbon refrigerants alone.

Lower Flammability Limit (LFL) and Upper Flammability Limit (UFL). LFL is the minimum concentration of each ingredient and/or blend in air that shows flammability, and UFL is the maximum concentration of each ingredient and/or blend in air that shows flammability. The difference (A) between UFL and LFL is wider for more flammable substances and narrower for less flammable substances. UFL and LFL may be determined according to Standard E681-09 of the American Society for Testing and Materials (ASTM), entitled “Standard Test Method for Concentration Limits of Flammability of Chemicals (Vapors and Gases), more specifically Annex A1, entitled “Test Method for Materials with Large Quenching Distances, Which May be Difficult to Ignite,” the disclosure of which is expressly incorporated herein by reference in its entirety. This test involves introducing the ingredient or blend into a vessel with air and igniting it with an electrical arc. Per ASTM-E681-09, the ingredient or blend is deemed flammable if flame propagation extends over a 45 degree angle line from the ignition source. UFL and LFL values of hydrocarbon refrigerants are well known and may be used as starting points for the test.

According to an exemplary embodiment of the present disclosure, the A of the blend (i.e., with the halocarbon refrigerants) may be smaller than the A of the hydrocarbon refrigerants alone (i.e., without the halocarbon refrigerants), which suggests that the flammability of the blend is reduced compared to the flammability of the hydrocarbon refrigerants alone. In certain embodiments, the A of the blend may be reduced by about 25%, 30%, 35%, 40%, 45%, 50%, or more relative to the A of the hydrocarbon refrigerants alone. For example, if the A of the hydrocarbon refrigerants alone is 8.0%, the A of the blend may be about 4.0% to 6.0%, or less. The flammability of the blend may be reduced until the blend is almost unable to sustain a flame.

Advantageously, the reduced flammability of the hydrocarbon blend may be achieved with a relatively low halocarbon content. Due to the relatively high hydrocarbon content of the blend, the blend may also exhibit favorable GWP, ODP, COP, and toxicity parameters. In the future, such hydrocarbon blends may become approved for more widespread use and in larger pieces of refrigeration equipment. Also, such hydrocarbon blends may reduce the usage of high-GWP halocarbon refrigerants.

### EXAMPLES

### Example #1

### Isobutane Refrigerant Blends having Reduced Flammability

Two refrigerant blends (B-5 and B-6) were prepared by blending relatively small amounts of tetrafluoroethane (R-134a) with isobutane (R-600a), as shown in Table 3 below.

TABLE 3

| | | Amount | | | | | |
|---|---|---|---|---|---|---|---|
| | | (by | | | Flammability | | |
| Blend | Ingredients | weight) | GWP | COP | LFL | UFL | Δ |
| — | isobutane | 100% | 3 | 2.87 | 1.8% | 9.6% | 7.8% |
| B-5 | tetrafluoro- | 10% | 135 | 2.90 | 4.0% | 9.1% | 5.1% |
| | ethane | | | | | | |
| | isobutane | 90% | | | | | |
| | Total | 100% | | | | | |
| B-6 | tetrafluoro- | 15% | 201 | 2.89 | 4.7% | 8.5% | 3.8% |
| | ethane | | | | | | |
| | isobutane | 85% | | | | | |
| | Total | 100% | | | | | |

Each blend was evaluated for GWP, COP, and flammability in the manner discussed above, the results of which are presented in Table 3. With the addition of tetrafluoroethane, GWP of each blend remained low (at 201 or less) and COP of each blend remained substantially unchanged. Compared to isobutane alone, the addition of tetrafluoroethane significantly decreased flammability. In fact, by including only 15 weight % tetrafluoroethane (B-6), flammability decreased by over 50% (from A 7.8% to 3.8%).

### Example #2

### Propane Refrigerant Blends having Reduced Flammability

Two refrigerant blends (B-7 and B-8) were prepared by blending relatively small amounts of pentafluoroethane (R-125) with propane (R-290), as shown in Table 4 below.

TABLE 4

| | | Amount | | | | | |
|---|---|---|---|---|---|---|---|
| | | (by | | | Flammability | | |
| Blend | Ingredients | weight) | GWP | COP | LFL | UFL | Δ |
| — | propane | 100% | 3.3 | 4.66 | 2.1% | 10.1% | 8.0% |
| B-7 | pentafluoro- | 10% | 348 | 4.64 | 4.2% | 8.9% | 4.7% |
| | ethane | | | | | | |
| | propane | 90% | | | | | |
| | Total | 100% | | | | | |
| B-8 | pentafluoro- | 15% | 520 | 4.66 | 4.6% | 8.6% | 4.0% |
| | ethane | | | | | | |
| | propane | 85% | | | | | |
| | Total | 100% | | | | | |

Each blend was evaluated for GWP, COP, and flammability in the manner discussed above, the results of which are presented in Table 4. With the addition of pentafluoroethane, GWP of each blend remained low (at 520 or less) and COP of each blend remained substantially unchanged. Compared to propane alone, the addition of pentafluoroethane significantly decreased flammability. In fact, by including only 15 weight % pentafluoroethane (B-8), flammability decreased by 50% (from Δ 8.0% to 4.0%).

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A refrigerant blend comprising:
a first percentage of at least one hydrocarbon refrigerant, the at least one hydrocarbon refrigerant having a flammability and a refrigerating capacity; and
a second percentage of at least one halocarbon refrigerant that reduces the flammability of the at least one hydrocarbon refrigerant by a third percentage;
wherein the second percentage is less than the third percentage; and
wherein the refrigerant blend has a refrigerating capacity greater than or substantially equal to the refrigerating capacity of the at least one hydrocarbon refrigerant.

2. The refrigerant blend of claim 1, wherein the second percentage is between about 5 weight % and about 20 weight %.

3. The refrigerant blend of claim 1, wherein the first percentage is about 80% or more.

4. The refrigerant blend of claim 1, wherein the second percentage is less than the first percentage.

5. The refrigerant blend of claim 1, wherein a coefficient of performance (COP) of the at least one hydrocarbon refrigerant is substantially the same as a COP of the refrigerant blend.

6. The refrigerant blend of claim 1, wherein a refrigerating capacity of the at least one hydrocarbon refrigerant is substantially the same as a refrigerating capacity of the refrigerant blend.

7. The refrigerant blend of claim 1, wherein the third percentage is at least about 25%.

8. The refrigerant blend of claim 7, wherein the third percentage is about 50%.

9. The refrigerant blend of claim 1, wherein a global warming potential (GWP) of the refrigerant blend is about 600 or less.

10. The refrigerant blend of claim 1, wherein an ozone depletion potential (ODP) of the refrigerant blend is about 0.2 or less.

11. The refrigerant blend of claim 1, wherein the at least one halocarbon refrigerant comprises a fluorocarbon.

12. The refrigerant blend of claim 11, wherein the at least one halocarbon refrigerant is selected from the group consisting of trichlorofluoromethane, dichlorofluoromethane, chlorotetrafluoroethane, pentafluoroethane, tetrafluoroethane, chlorodifluoroethane, difluoroethane, chlorodifluoromethane, and difluoromethane.

13. The refrigerant blend of claim 1, wherein the at least one hydrocarbon refrigerant is selected from the group consisting of propane, butane, isobutane, cyclopropane, ethane, methane, pentane, and heptane.

14. A refrigerant blend comprising:
at least one hydrocarbon refrigerant having a hydrocarbon content in the refrigerant blend, the at least one hydrocarbon refrigerant having a flammability; and
at least one halocarbon refrigerant having a halocarbon content in the refrigerant blend to reduce the flammability of the at least one hydrocarbon refrigerant;
wherein the refrigerant blend has a global warming potential (GWP) of about 600 or less.

15. The refrigerant blend of claim 14, wherein the halocarbon content is between about 5 weight % and about 20 weight %.

16. The refrigerant blend of claim 14, wherein the hydrocarbon content is at least about 4 times greater than the halocarbon content.

17. The refrigerant blend of claim 14, wherein an ozone depletion potential (ODP) of the refrigerant blend is about 0.2 or less.

18. A method of producing a refrigerant blend comprising:
providing at least one hydrocarbon refrigerant having a flammability;
reducing the flammability of the at least one hydrocarbon refrigerant by adding at least one halocarbon refrigerant to the at least one hydrocarbon refrigerant to produce a refrigerant blend; and
maintaining a global warming potential (GWP) of the refrigerant blend at about 600 or less.

19. The method of claim 18, further comprising maintaining a coefficient of performance (COP) of the refrigerant blend substantially constant.

20. The method of claim 18, wherein the reducing step reduces the flammability of the at least one hydrocarbon refrigerant by at least about 25%.

21. The method of claim 20, wherein the reducing step reduces the flammability of the at least one hydrocarbon refrigerant by about 50%.
